(19) United States
(12) Patent Application Publication
(10) Pub. No.: US 2004/0028507 A1
(43) Pub. Date: Feb. 12, 2004

(54) Robotically manipulable tool with on-board processor

(76) Inventor: Peter Massaro, Burlington, CT (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/622,415

(22) Filed: Jul. 18, 2003

Related U.S. Application Data
(60) Provisional application No. 60/397,990, filed on Jul. 23, 2002.

(51) Int. Cl. B25J 1/00

(52) U.S. Cl. 414/4; 483/901

(57) ABSTRACT

A robotically manipulable tool, such as a colony picking head or robotic pipetting tool, includes a processor on the tool. The processor may receive high level instruction from a robot controller and use the instruction to cause devices on the tool to perform desired functions. The processor can also store maintenance and other information regarding past use or repair of the tool. In addition, the processor may perform self-diagnostic tests on the tool or be used to perform functions during bench testing of the tool.

### RELATED APPLICATIONS

This application claims priority to U.S. provisional application Ser. No. 60/397,990, filed Jul. 23, 2002.

### BACKGROUND OF THE INVENTION

1. Field of Invention

This invention relates to robotically manipulable tools, such as interchangeable robotic sample handling devices.

2. Related Art

Robotically manipulated tools are widely used in a variety of applications. For example, robots used in automated proteomic and genomic research employ multiple, different tools to perform different operations. One type of tool may be used by the robot to move material samples both to and from a variety of different work areas, such as microtiter trays, gels having separated DNA fragments, and other material holding devices. This tool may be changed by the robot for another tool, such as a gripping tool, to perform other functions. Thus, multiple, interchangeable tools each specially adapted for performing one or more functions may be handled by the robot to perform a variety of processes.

Each of the interchangeable tools used by the robot are typically controlled by the robot controller. That is, the robot controller, e.g., a programmed computer that is part of the robot, that provides signals to portions of the robot to move parts of the robot in a desired way also sends signals to the tool to cause the tool to perform desired functions. In the case where the robot may use multiple, different tools, the robot controller must be configured to recognize many different tools that may be linked to the robot. The robot controller must not only recognize such tools, but also provide custom sets of signals to the tool to make it operate. For example, the robot controller may be required to provide certain signals to a liquid handling tool to cause it to aspirate, dispense or otherwise handle liquid samples. However, other types of tools, such as gripping tools, may require other signals. Moreover, even different types of tools in same class, such as different types of liquid handling tools, may require different signals to operate since the tools may have numbers of, or types of, actuators, use different communication protocols, etc. As a result, the robot controller must be specially configured for each particular tool that it uses and be capable of providing detailed instructions for operating each device on the tool.

### SUMMARY OF THE INVENTION

In one aspect of the invention, a processor is provided on an interchangeable robotic tool. Placing a processor on a robotic tool can provide a variety of benefits, such as allowing the robot controller to control the operation of a certain class of tools, e.g., liquid handling tools, using a common set of instructions. For example, the processor on any one of the tools can be configured to receive one or more signals from a common set of signals used by the robot controller, decode the signal(s) received from the controller, and use the decoded signals to cause appropriate actuation of the tool. As used herein, “decode” refers to any suitable type of processing of a signal to interpret one or more instructions contained in the signal for purposes of causing the tool to perform the desired functions. Decoding may include parsing a high-level instruction, such as “dispense at needle 36”, into multiple functions that may need to be performed to achieve the function, such as “activate switch, read encoder, activate drive motor, detect dispensed volume”, etc. Thus, the robot controller need not necessarily be configured to interact with each individual tool that may be used with the robot, but instead the tools may be configured to operate using a set of instructions provided by the robot controller. This also allows the robot controller to provide high-level instructions to the tools and does not require “knowledge” at the robot controller regarding the specific operations performed by the tool to achieve the desired result.

The on-tool processor can also perform other useful functions, such as self-diagnostic tests, storing and processing tool maintenance information, and/or providing intelligent feedback to the robot controller.

These and other aspects of the invention will be apparent and/or obvious from the following description and appended claims.

### BRIEF DESCRIPTION OF THE DRAWINGS

Illustrative embodiments in accordance with the invention are described below with reference to the following drawings, in which like numerals reference like elements, and wherein:

FIG. 1 is a schematic diagram of a robotically manipulated tool in accordance with the invention; and

FIG. 2 is a schematic, perspective view of a tool in accordance with the invention.

### DETAILED DESCRIPTION

Various aspects of the invention are described below with reference to illustrative embodiments. However, it should be understood that the invention is not limited to those embodiments described below, but instead may be used in any suitable system or arrangement.

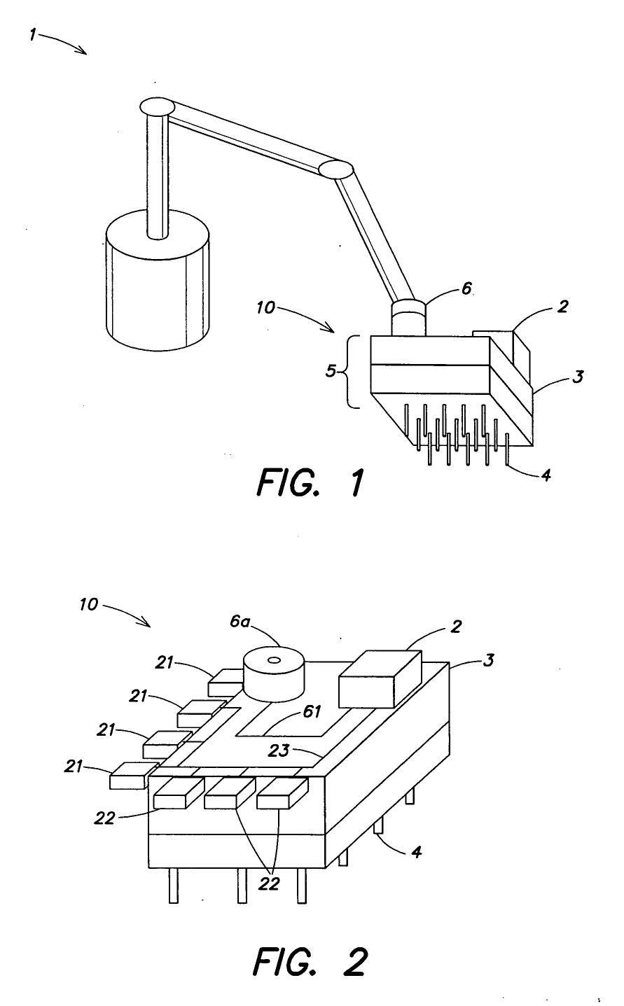

FIG. 1 is a schematic diagram of a robot 1 manipulating an interchangeable tool 10 in accordance with the invention. In this illustrative embodiment, the tool 10 is a material handling tool that the robot 1 may use to move, mix, or otherwise manipulate material samples for genomic or proteomic processing. For example, needles 4 on the tool 10 may be used to pick up and/or deposit material on one or more work areas, such as microtiter trays, gels containing separated DNA fragments or other biologic materials, etc. The robot 1 may move the tool 10 so that one or more needles 4 are appropriately positioned with respect to a microtiter tray and then actuate one or more needles 4 to remove material from, or deposit material in, wells in the microtiter tray. Those of skill in the art will understand that the needles may be actuated to perform other material handling operations, such as colony or plaque picking at the direction of a machine vision system. It should also be understood, however, that aspects of the invention are not limited to a material handling tool like that shown. Instead, the tool 10 may perform any suitable function or functions and be any suitable type of tool used by a robot, such as a gripping tool, drilling tool, machine vision tool, etc.

Although the robot 1 is shown in FIG. 1 as having a base and an articulated arm, the robot 1 may be of any suitable type or construction and may be capable of moving the tool 10 in any suitable number of degrees of freedom. For example, the robot may be a gantry-type robot capable of moving the tool 10 in three degrees of freedom. Of course, other suitable robotic configurations capable of moving the tool 10 in one or more degrees of freedom may be used. The robot controller (not shown) may include a vision system, position sensors or other suitable devices to control positioning of the tool 10, as is well known.

In this illustrative embodiment, the robot 1 may change the tool 10 for other tools to perform a variety of different functions. Thus, the tool 10 and robot 1 may include corresponding couplings 6 to allow the robot 1 to connect with the tool 10, e.g., pick up the tool 10, manipulate the tool 10 for performing functions, and disconnect from (e.g., drop) the tool 10 to interchange for another tool, thereby allowing the robot 1 to perform automated operations with different tools. The coupling 6 between the tool 10 and the robot 1 may provide physical support to the tool 10 as well as provide electrical power, control signals, a fluid supply or other fluid signal, etc. As used herein, “fluid” refers to gases and/or liquids. Thus, the tool 10 may use electrical, fluid, mechanical or any other suitable signals received via the coupling or otherwise (e.g., via wireless signal) to operate. Using signals received from the robot controller, the processor 2 may cause actuators 3 or other portions of the tool 10 in the tool body 5 to perform desired functions. The actuators 3 and other portions of the tool 10 are shown in schematic form in FIG. 1, but those of skill in the art will appreciate that actuators and other devices for performing functions on the tool may take any suitable form.

Although the processor 2 may receive signals in any suitable way such as by wired or wireless link, as shown in FIG. 2, the processor 2 in this embodiments receives signals via one or more lines 61 in communication with the coupling 6. The signals received may be provided in any suitable format, communications protocol, etc. For example, the signals may be electrical and/or optical signals and may be in digital and/or analog format. Information may be coded in the signals in any suitable way, as is well known in the art.

The processor 2 may decode the received signals or otherwise process the signals so that the tool 10 can be suitably controlled. For example, the processor 2 may receive a high-level instruction from the robot controller and decode the instruction to generate one or more signals to cause appropriate signals to be sent to different switches 21 and 22, actuators 3 or other portions of the tool 10. In the illustrative embodiment of FIG. 2, the processor may cause signals to be sent to switches 21 and 22, actuators 3 or other components via one or more lines 23. In response, the switches 21 and 22, actuators 3 or other components may actuate parts of the tool 10 to perform the function instructed by the robot controller in the high-level instruction. For example, the robot controller may provide an instruction to the processor 2 to dispense fluid from one or more needles 4 on the tool. The processor 2 may process the instruction and cause suitable signals to be sent to the switches 21 and 22 and/or actuators 3 to cause the appropriate needle(s) 4 to be actuated. Actuation of a needle 4 may cause the needle 4 to move relative to the tool 10, such as extend away from the tool to pick or place material on a work area, control flow in the needle, such as drawing fluid into or expelling fluid out from the needle, or otherwise cause the needle to perform one or more material handling functions. Of course, the tool 10 is not limited to actuating needles 4 or other similar devices, but instead may perform any suitable function using any suitable devices.

The processor 2 may be associated with a controller on the tool 10 that provides any suitable signal or combination of signals to the switches 21 and 22, actuators 3 or other components on the tool 10. For example, at the instruction of the processor 2, the controller may provide electrical signals, magnetic signals, optical signals, fluid signals (e.g., changes in fluid pressure and/or flow), or combinations of such signals, such as providing both an electrical signal and a fluid signal to components on the tool 10. Typically, signals provided by the controller will depend upon the type of actuators or other components on the tool. For example, the actuators 3 may be pneumatically-controlled fluid valves that open, close or otherwise change state based on a fluid signal. Of course, the actuators 3 may include electrically-controlled fluid valves, relays, or other suitable devices to actuate a corresponding needle or other device. For example, the tool 10 may include one actuator for each needle, where each actuator includes a valve and associated pneumatic ram such that when the valve is open and air pressure is supplied through the open valve, the pneumatic ram may extend, and thereby extend a corresponding needle 4 from the body 5. Thus, the actuators may be responsive to two or more signals received from the controller to actuate the needles 4.

The robot controller and/or processor 2 may include any suitable general purpose data processing system, which can be, or include, a suitably programmed general purpose computer, or network of general purpose computers, and other associated devices, including communication devices, and/or other circuitry or components necessary to perform the desired input/output or other functions. The robot controller/processor 2 can also be implemented at least in part as single special purpose integrated circuits (e.g., ASICs), or an array of ASICs, each having a main or central processor section for overall, system-level control and separate sections dedicated to performing various different specific computations, functions and other processes under the control of the central processor section. The robot controller/processor 2 can also be implemented using a plurality of separate dedicated programmable integrated or other electronic circuits or devices, e.g., hardwired electronic or logic circuits, such as discrete element circuits or programmable logic devices. The robot controller or controller associated with the processor 2 on the tool may also include other devices, such as an information display device, user input devices, data storage devices, communication devices, valves, motors, mechanical linkages or other electronic circuitry or components.

The processor 2 can also perform other useful functions besides processing instructions from the robot controller. For example, the processor 2 may store maintenance information for portions of the tool 10. For example, the processor 2 may store information regarding the number of cycles performed by one or more portions of the tool 10, and notify the robot controller or otherwise indicate that the tool 10 should be inspected when the number of cycles reaches a particular level. As one example, a needle actuator 3 may be built to perform 100,000 cycles between maintenance checks. The processor 2 may count cycles performed by the actuator 3 and indicate when 100,000 cycles have been reached. The tool 10 may then be taken out of service and inspected and/or rebuilt or repaired as necessary.

The processor 2 may also communicate with sensors on the tool 10 to provide intelligent feedback to the robot controller. That is, the processor 2 may receive input from one or more sensors, process the input and provide information to the robot controller. For example, the processor 2 may receive input from a position encoder on the tool 10 that indicates the relative positions of two portions on the tool 10, such as the position of a pipette plunger relative to the cylinder in which the plunger reciprocates. The processor 2 may detect that the position information provided by the encoder indicates that movement of the plunger relative to the cylinder is not appropriate, e.g., the position information may indicate that the plunger is moving in an inconsistent or jerky manner relative to the cylinder as a result of a loose part. The processor 2 may indicate the problem so the tool 10 can be inspected and/or taken out of service as necessary. Those of skill in the art will appreciate the variety of self-diagnostic tests that may be performed by the processor 2.

The processor 2 may also cause the tool 10 to perform a start-up or shut-down routine or any other suitable routine, e.g., when the tool 10 is bench tested during maintenance. Thus, a technician may provide a suitable power supply and instructions to the processor 2 during a bench test so the tool 10 performs certain functions without being linked to a robot. Maintenance or other information may also be stored by the processor 2 so that maintenance and other records are kept with the tool 10 and can be accessed at any time from the tool 10. This may be useful when tools 10 are inspected and/or maintained at dispersed locations since maintenance information need not be kept at and retrieved from a central location. Instead, a technician can get information regarding the tool from the tool itself. As an example, a technician may wish to know what version a particular tool is and who last performed maintenance on the tool 10 so the technician can obtain the proper parts and ask the prior technician how the previous repair was performed. This information may be readily retrieved from the processor 2.

While the invention has been described with reference to various illustrative embodiments, the invention is not limited to the embodiments described. Thus, it is evident that many alternatives, modifications, and variations of the embodiments described will be apparent to those skilled in the art. Accordingly, embodiments of the invention as set forth herein are intended to be illustrative, not limiting. Various changes may be made without departing from the invention.

1. A robotically manipulable tool, comprising:
a tool body;
a coupling attached to the tool body constructed and arranged to mate with a corresponding coupling on a robot and allow the robot to mechanically connect with the tool, manipulate the tool, and mechanically disconnect from the tool;
at least one device mounted to the tool body for performing a function of the tool; and
a processor on the tool body constructed and arranged to receive a signal from a robot controller requesting the tool to perform the function, process the signal, and cause the at least one device to perform the function.

2. The tool of claim 1, wherein the processor is constructed and arranged to receive a high level instruction from the robot controller, decode the instruction and cause the at least one device to perform a function based on the decoded instruction.

3. The tool of claim 1, wherein the processor is constructed and arranged to store information regarding past functions performed by the at least one device.

4. The tool of claim 1, wherein the processor is constructed and arranged to perform at least one diagnostic test of the at least one device on the tool.

5. The tool of claim 1, wherein the processor is constructed and arranged to receive information from a sensor on the tool, process the information and provide intelligent information to the robot controller as a result of processing the information from the sensor.

6. The tool of claim 1, wherein the coupling is constructed and arranged to electrically couple the robot and the tool.

7. The tool of claim 1, wherein the coupling is constructed and arranged to allow signals to be transmitted between the robot and the processor via the coupling.

8. The tool of claim 1, wherein the coupling is constructed and arranged to allow at least one of electrical, optical and fluid signals to be transmitted between the robot and the tool.

9. The tool of claim 1, wherein the at least one device is constructed and arranged to liquid handling functions suitable for genomic or proteomic processing.

10. The tool of claim 1, wherein the processor is constructed and arranged to cause the tool to perform functions without the tool being coupled to a robot.
